(19) United States
(12) Patent Application Publication
(10) Pub. No.: US 2004/0202342 A1
(43) Pub. Date: Oct. 14, 2004

(54) Compound loudspeaker drive unit having a magnet system

(75) Inventors: Philip Jeffrey Anthony, Singleton Ashford (GB); Enrico Cecconi, New Ash Green (GB)

Correspondence Address: Kenneth L. Sherman, Esq., Myers Dawes Andras & Sherman, LLP, 11th Floor, 19900 MacArthur Blvd., Irvine, CA, 92612, US

(73) Assignee: KEF AUDIO (UK) LIMITED, Maidstone (GB)

(21) Appl. No.: 10/803,676

(22) Filed: Mar. 18, 2004

Related U.S. Application Data
(62) Division of application No. 09/669,308, filed on Sep. 25, 2000.

(30) Foreign Application Priority Data
Jul. 11, 2000 (GB) 0017072.0

(51) Int. Cl. H04R 1/02

(52) U.S. Cl. 381/342

(57) ABSTRACT

A mid and high frequency transducer having a compact magnet system. A first seat has an annular wall that retains a first disk shaped magnet therein and an annular channel is defined therebetween. A second seat rests on top of the first magnet and first seat and is connected thereto but does not occlude the annular opening. The second seat has an annular wall that retains a second disk shaped magnet therein such that a uniform annular gap is defined therebetween. A first voice coil is connected to a first diaphragm and is moveably suspended within annular channel and a second voice coil is connected to a second diaphragm and is moveably suspended within the annular gap. Application of an electric current to the voice coils causes movement of the diaphragms due to the magnetic flux created within the annular channel and gap and thereby produces sound waves.

### FIELD OF THE INVENTION

This invention relates to transducers and magnets contained therein, and particularly to low and high frequency transducers, such as compound loudspeakers, having a combined magnet system.

### BACKGROUND OF THE INVENTION

Conventional speakers utilize standard ferrous magnets in conjunction with a voice coil to control the speaker cone, dome, or other diaphragm. However, such magnets are relatively large and heavy and produce stray magnetic fields which require bulky shielding to contain or increased distance therebetween and unnecessarily. increase both the size and weight of the speaker.

It is desirable in high fidelity speakers to place the high frequency diaphragm as close to the mid to low frequency diaphragm as possible so that the sound appears to come from a single source. To achieve this result, it is known that a sub-compact assembly is required. It has been found that such a sub-compact design can be achieved by utilizing high energy magnets, such as magnets formed of neodymium-iron-boron in place of the standard ferrous magnets.

However, even with the use of the neodymium-iron-boron magnets, assemblies of the drive units are still bulky and complicated requiring numerous parts and numerous steps to assemble. For example, U.S. Pat. No. 5,548,657 to Fincham discloses a compound loud speaker drive unit that has a first transducer for producing sounds in the low frequency range and a second transducer for producing sounds in the high frequency range. However, the large magnetic structure and the complicated assembly thereof adds to the overall depth and weight of the drive units in an undesired fashion.

Therefore, there remains a long standing and continuing need for an advance in the art of compound loud speakers that is simpler in both design and use, is more economical, compact, and efficient in its construction and use, and can quickly be assembled while eliminating the need for larger magnets and drive units.

### SUMMARY OF THE INVENTION

Accordingly, it is a general object of the present invention to overcome the disadvantages of the prior art.

In particular, it is an object of the present invention to provide a compound loud speaker with fewer parts.

It is another object of the present invention to provide a compound loud speaker wherein the transducers are reduced in size.

It is another object of the present invention to provide a compound loud speaker wherein the assembly is reduced in weight.

It is another object of the present invention to provide a compound loud speaker wherein the magnets and their housing is relatively compact.

It is yet another object of the present invention to provide a compound loud speaker wherein the transducers are reduced in weight.

It is yet another object of the present invention to provide a compound loud speaker that is easily and quickly assembled and disassembled.

It is yet another object of the present invention to provide a compound loud speaker wherein the magnet structures can be magnetized in unison after assembly thereof.

It is yet another object of the present invention to provide a compound loud speaker wherein the high frequency voice coil and the low frequency voice coil are in close proximity to one another.

In keeping with the principles of the present invention, a unique high frequency loudspeaker is presented which overcomes the shortfall of the prior art. The loudspeaker has a circular first seat that has a peripheral annular wall that extends perpendicularly therefrom. First seat is a magnet pot and is preferably constructed of steel. A first magnet that is preferably disk shaped is received within the wall of first seat to form a uniform channel between the first magnet and the wall. First magnet is preferably the same height as the wall to form an even plane. At least an aperture extends through first seat at a position between first magnet and the wall wherein the channel is defined. First magnet is attached to the floor of the first seat by any adhesive means that is known in the art such as, but not limited to, structural adhesives.

A second seat, preferably being circular in nature, is positioned upon first magnet and wall of first seat without occluding the uniform channel. Second seat has an annular protrusion that extends in an opposing direction from said first seat and encircles a second disk shaped magnet therein. An annular opening is defined between the protrusion and the second magnet.

The second seat has an annular flange that extends past the annular protrusion and rests upon the annular wall of the first seat. The flange is provided with a means for binding the second seat to the annular wall of the first seat. At least a void is defined through the flange and the void is in substantial axial alignment with the aperture of the first seat to allow electrical conductors to pass therethrough.

The second magnet has a disk shaped plate thereon that is preferably of the same radius as the magnet. The plate has a dome shaped diaphragm thereon that is moveably suspended thereon. The dome shaped diaphragm has a voice coil thereon that extends into the annular gap. As a current is applied to the voice coil, the voice coil is forced to move within the gap due to the magnetic flux created by the magnets. Accordingly, the dome moves back and forth and thereby generates audio output.

An annular chassis is positioned over the flange of the second seat and the chassis moveably maintains a generally conical diaphragm thereon. A second voice coil is maintained on the conical diaphragm and extends into and within the opening defined between the annular wall and the first disk shaped magnet. As current is applied to the second voice coil, the voice coil is forced to move within the annular opening due to the magnetic flux created by the magnets. Accordingly, the conical diaphragm moves back and forth and thereby generates audio output.

As a result, the disk shaped first and second magnets reduce the number of parts necessary to assemble the compound loud speaker. In addition, the compact nature of the magnets allows the first and second voice coils to be proximal in distance to allow coincidence of the sound source thereby increasing clarity. In addition, the present arrangements of the two magnets allows the option of magnetizing the two magnets simultaneously after they have been assembled.

Such stated objects and advantages of the invention are only examples and should not be construed as limiting this invention. These and other objects, features, aspects, and advantages of the invention herein will become more apparent from the following detailed description of the embodiments of the invention when taken in conjunction with the accompanying drawings and the claims that follow.

### BRIEF DESCRIPTION OF THE DRAWINGS

It is to be understood that the drawings are to be used for the purposes of illustration only and not as a definition of the limits of the invention.

In the drawings, wherein similar reference characters denote similar elements throughout the several views:

FIG. 1 is a top plan view of the high frequency domed diaphragm as connected to the driver portion of the invention.

FIG. 2 is a cross-sectional view of a high frequency domed diaphragm and the driver portion taken along line 2-2 of FIG. 1.

FIG. 3 is a cross sectional view of the loudspeaker also illustrating the chassis and the low frequency diaphragm.

FIG. 4 is a top plan view of a compound loud speaker.

FIG. 5 is a cross sectional view of an alternate preferred embodiment of the loudspeaker also illustrating the chassis and the low frequency diaphragm.

FIG. 6 is a cross sectional view of the driver portion and the high frequency dome of an alternate preferred embodiment.

### DETAILED DESCRIPTION OF THE INVENTION

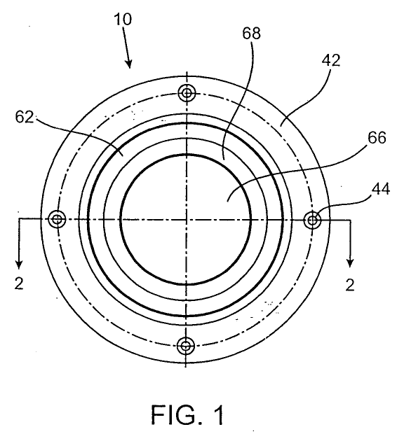

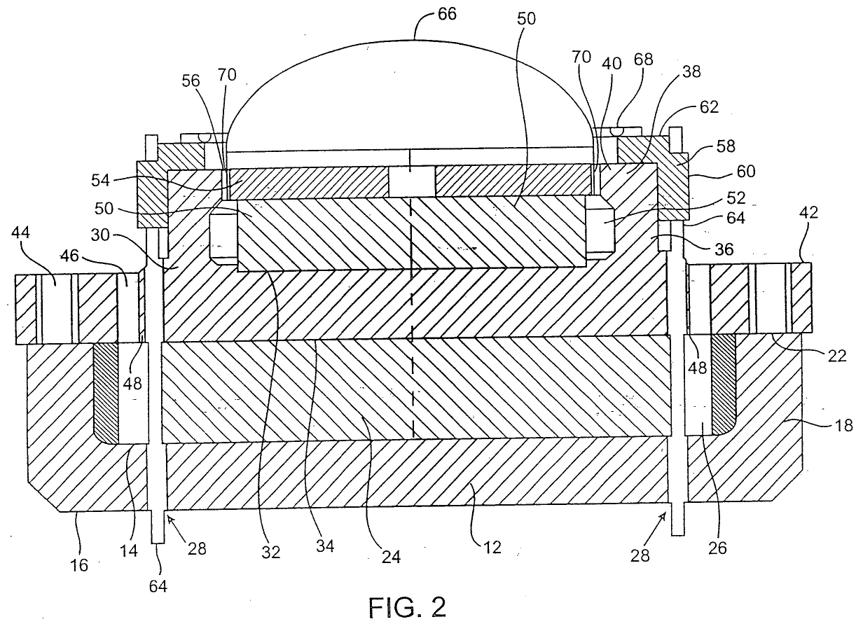

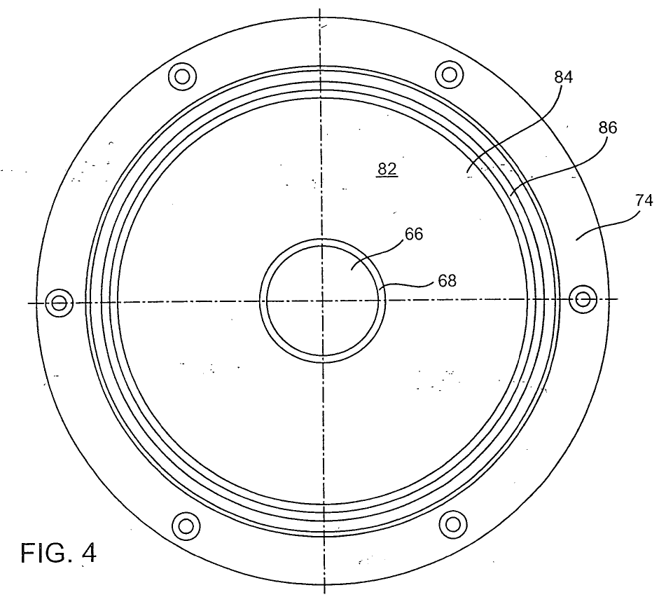

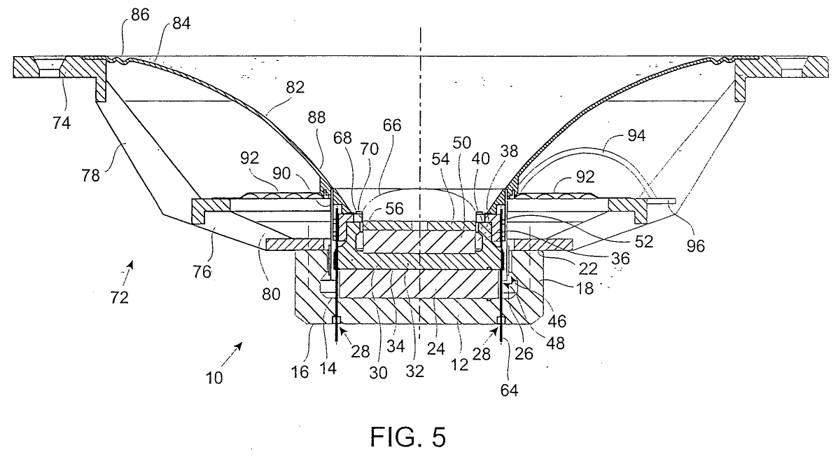

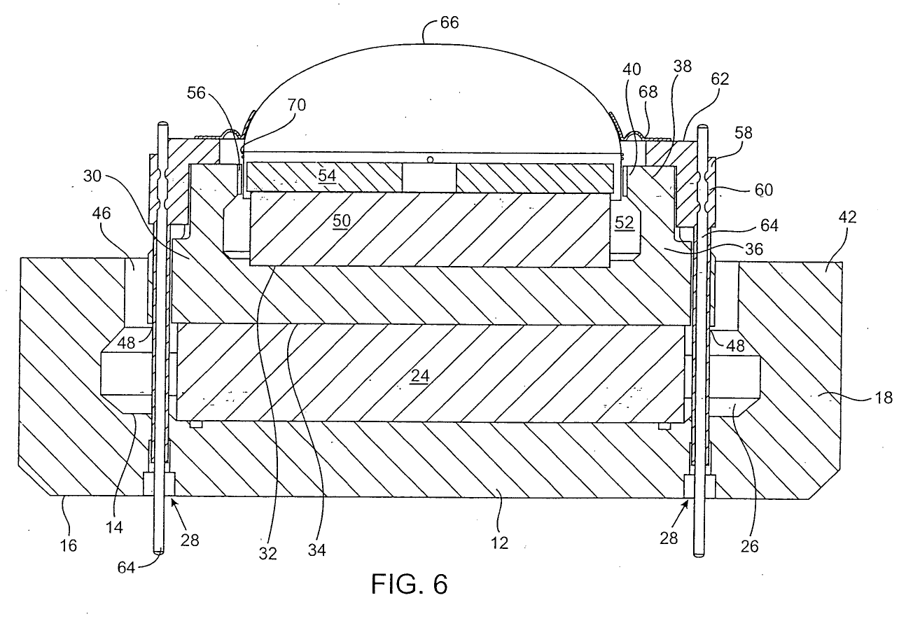

Referring to FIGS. 1 through 6, therein are illustrated several views of preferred embodiments of a transducer 10 in the form of a compound loudspeaker. Transducer 10 has a first seat 12 having a top surface 14 and a bottom surface 16. A wall 18 extends perpendicularly from top surface 14 at an outer portion of first seat 12. First seat 12 is preferably circular and wall 18 is annular. First seat 12 may be a magnet pot and is preferably constructed of steel, but is not limited thereto.

A first magnet 24, that is preferably disk shaped, is received within first seat 12 on top surface 14 thereof, such that a substantially uniform channel 26 is maintained between first magnet 24 and wall 18. First magnet 24 may be attached to top surface 14 of seat 12 by any attaching means that is known in the art such as, but not limited to, structural adhesives. In addition, first magnet 24 is adapted to be substantially even in height with a top end 22 of wall 18. At least an aperture 28 extends from top surface 14 and out through bottom surface 16 of first seat 12. Aperture 28 is preferably positioned between first magnet 24 and wall 18 and is generally below channel 26.

A second seat 30 having a top side 32 and a bottom side 34 is positioned upon first magnet 24 such that bottom side 34; contacts magnet 24 at an end opposing said first seat 12. Second seat 30 may be attached to magnet 24 by any attaching means that is known in the art such as, but not limited to, structural adhesives. Second seat 30 may be a magnet pot and is preferably constructed of steel, but is not limited thereto and may be made of any suitable material that is known in the art. Second seat 30 is preferably circular in nature and has a protrusion 36 extending perpendicularly from top side 32 and forming an annular wall. At an upper end 38 of protrusion 36, an annular lip 40 extends perpendicularly inward from protrusion 36 and is substantially parallel to top side 32.

An annular flange 42 extends outwardly from second seat 30 at an even plane with bottom side 34 and rests on top end 22 of wall 18. Flange 42 defines at least a cavity 44 therein, and preferably four equidistantly spaced cavities 44 on said flange 42, such that the cavity 44 rests on top end 22. Cavity 44 can accommodate a binding means such as, but not limited to, a threaded element so that second seat 30 may be removably attached to first seat 12. At least an opening 46 is preferably annular and is also defined by flange 42, and opening 46 is more medially positioned in relation to cavity 44. At least a void 48 is also defined through flange 42 and void 48 is more medially positioned than opening 46. In addition, void 48 is in substantial axial alignment with aperture 28. In a preferred embodiment, two voids 48 are located opposing each other on a central line that equally bisects second seat 30.

A second magnet 50 having a substantially disc shape is placed on top of top side 32 of second seat 30 such that it is equidistantly spaced from protrusion 36 whereby an annular groove is created therebetween. A plate 54 is positioned upon said second magnet 50 such that plate 54 is in a congruent plane with lip 40 of protrusion 36. Second magnet 50 may be attached to second seat 30 and plate 54 by any attaching means that is known in the art such as, but not limited to, a structural adhesive. An annular gap 56 is defined between an outer edge 34 of plate 30 and flange 26 of wall 24. In a preferred embodiment, annular gap 56 may be injected with a metallic fluid, preferably a ferrofluid, or with some other substance that has good heat transfer characteristics but does not interfere with movements of components therein.

A spacer 58, having an annular shape, is positioned over an outer surface of protrusion 36 of second seat 30. Spacer 58 has a vertical portion 60 that connects to an outer surface of protrusion 36, and a horizontal portion 62 that connects to an upper region of lip 40. Vertical portion 60 is preferably in axial alignment with void 48 and aperture 28 and is adapted to receive an electrical conducting element 64 that passes through void 48 and aperture 28. Horizontal portion 62 is also adapted to accommodate element 64 therethrough. Element 64 is an electrical conductor that is electrically insulated from first seat 12, second seat 30, and channel 26 as it passes therethrough.

A high frequency domed diaphragm 66 has an annular support 68 at an outer periphery thereof that is of annular corrugated form and support 68 is connected to spacer 58 in a movable fashion. Secured to diaphragm 66 is a cylindrical coil former carrying a high frequency voice coil 70 such that the voice coil extends through the gap 56. Diaphragm 66 may be constructed of a variety of rigid materials, and in a preferred embodiment, diaphragm 66 is constructed from metals such as, but not limited to, titanium or aluminum. Diaphragm 66 may also be constructed from a plurality of alloys containing metals such as, but not limited to, aluminum and boron. In addition, diaphragm 66 may also be made of a soft material such as, but not limited to, sealed cloth, flexible materials such as plastics, or other suitable material that is known in the art. In operation, as current is applied to conducting element 64 and in turn to voice coil 70, voice coil 70 is forced to move in gap 56 due to the magnetic flux created by first magnet 24 and second magnet 50, lip 40, second seat 30, and plate 54. In turn the domed diaphragm 66 is caused to move back and forth axially. As the dome moves forward, it compresses the air in front of it and as the dome moves backward it rarefies the air in front of it, and thus the desired audio output is produced by the numerous compressions and rarefactions.

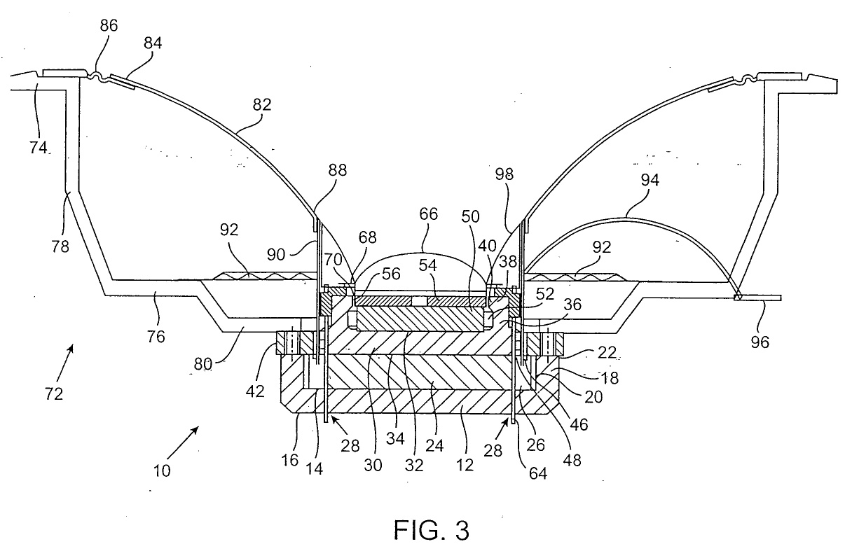

Now referring specifically to FIGS. 3, 4, 5, and 6 a chassis 72 has a front annular projection 74 and a rear annular member 76 that are interconnected by a plurality of ribs 78. Rear annular member 76 has a medially projecting annular brim 80. Annular brim 80 is connected to flange 42 of second seat 30 in a secure yet removable fashion and is fitted thereon in such a fashion as not to occlude opening 46.

A second diaphragm 82 comprises the mid to low frequency diaphragm and is of generally frusto-conical form. At an outer edge 84, the second diaphragm 82 is connected to projection 74 via a flexible surround 86. At an inner edge 88, the second diaphragm 82 is connected to a tubular coil former 90 and coil former 90 is adapted to extend into the opening 46 defined by flange 42. Coil former 90 carries the mid to low frequency voice coil thereon such that the coil extends through opening 46.

A suspension member 92, that is annular and flexible in nature is secured between annular member 76 of chassis 72, and the coil former 90 in order to ensure that coil former 90 and the voice coil carried thereon are maintained concentric with and within opening 46 and out of physical contact with the surrounding elements during sound producing movements of second diaphragm 82. The length of the coil former 90 may be extended or shortened as desired to control the distance of second diaphragm 82 from domed diaphragm 66. Connections to the mid to low frequency voice coil are provided by means of flexible leadout conductors 94 extending from the voice coil to external connectors 96.

It will be appreciated that with the high frequency drive unit positioned at or adjacent to the neck of the second diaphragm 82 of the mid to low frequency drive unit, as above described, the apparent sound source or acoustic center of the high frequency drive unit is substantially co-incident with the apparent sound source or acoustic center of the mid to low frequency drive unit.

The radiation pattern or directivity of the low frequency drive unit is determined inter alia by the form of the low frequency second diaphragm 82 and an annular wave guide 98 surrounding said domed diaphragm 66. With the high frequency drive unit positioned adjacent to the neck of the mid to low frequency second diaphragm 82, the form of the mid to low frequency cover imposes its directivity upon the radiation pattern or directivity of the high frequency unit. Consequently, at frequencies at which both drive units contribute significant sound output both drive units have substantially similar patterns of radiation or directivity. As a result, the relative sound contributions from the two drive units as perceived by a listener are substantially unaffected by the listener being positioned at off axis positions.

The mid to low frequency diaphragm is shown to be a cover of conical form having an angle of flare which increases from inner edge 88 to outer edge 84. However, it will be appreciated that the cover may be of conical form having a uniform angle of flare. Also, the mid to low frequency cover may be of circular, elliptical, square, rectangular, or other section as desired.

The high frequency diaphragm 66 is shown in the drawing as being of domed form. Such a diaphragm is suitable because its acoustic center may be readily located in close coincidence with that of the mid to low frequency diaphragm, and because, in the frequency range where both units contribute significant sound output, its small size relative to wavelength gives it, by itself, essentially non-directional sound radiation, allowing the effective directivity to be determined by the mid to low frequency diaphragm. It will be appreciated that the high frequency diaphragm 66 may alternatively be of any other form that provides these characteristics.

It will also be appreciated that the arrangement of the first magnet 24 and second magnet 50 of the present invention reduces the number of parts necessary to assemble the two drive units. In addition, the present arrangement of the two magnets allows the magnetization thereof as an assembly, whereas, in the prior art, each magnet had to be magnetized individually and then assembled. Furthermore, the present magnets may either have similar polarity, thereby allowing magnetization as an assembly, or may have opposite polarities, wherein the magnets are individually magnetized and then assembled.

While the above description contains many specificities, these should not be construed as limitations on the scope of the invention, but rather as an exemplification of one preferred embodiment thereof. Many other variations are possible without departing from the essential spirit of this invention. Accordingly, the scope of the invention should be determined not by the embodiment illustrated, but by the appended claims and their legal equivalents.

1. A high frequency transducer, comprising:
a first diaphragm having a first coil thereon;
a second diaphragm having a second coil thereon formed on a periphery of said first diaphragm;
a first seat having a first magnet structure, said first seat defining an annular opening to allow said second coil to be moveably suspended therein; and
a second seat having a second magnet structure, said second seat and said second magnet defining an annular gap to allow said first coil to be moveably suspended therein.

2. The invention of claim 1, wherein said first and second magnets are substantially disk shaped.

3. The invention of claim 1, wherein said first and second magnets are substantially flat in structure.

4. The invention of claim 2, wherein said first magnet and said second magnet can be magnetized after assembly.

5. The invention of claim 2, wherein said first magnet and said second magnet can be magnetized simultaneously after assembly.

6. The invention of claim 2, wherein said first magnet and said second magnet have similar polarity.

7. The invention of claim 2, wherein said first and second magnets are neodymium iron boron magnets.

8-11. (Canceled).

12. The invention of claim 2, wherein said annular gap contains a substance having high heat transfer capability.

13. The invention of claim 12, wherein said substance is a metallic fluid and is injected into said annular gap.

14. The invention of claim 13, wherein said metallic fluid is a ferrofluid and is injected into said annular gap.

15-20. (Canceled).

21. The invention of claim 1, wherein a magnetic flux path generated by the first magnet and by the second magnet, affects the flux density in both the annular gap and the annular opening.

22. The invention of claim 1, wherein the first seat including said first magnetic structure, and the second seat including said second magnetic structure, form an essentially non-separable, single magnetic assembly.
